(19) United States
(12) Patent Application Publication
(10) Pub. No.: US 2015/0367157 A1
(43) Pub. Date: Dec. 24, 2015

(54) System, Method, Apparatus, and Computer Program Product for Testing a Vehicle Fire Suppression System

(71) Applicant: McWane, Inc., Birmingham, AL (US)

(72) Inventors: Michael Lawrence Rohlik, Raleigh, NC (US); Kenneth Alan Hubbard, Youngsville, NC (US); John Emmett Bevins, Trussville, AL (US)

(21) Appl. No.: 14/312,299

(22) Filed: Jun. 23, 2014

(51) Int. Cl. A62C 37/50; A62C 35/11; G01K 13/00; A62C 3/07

(52) U.S. Cl. CPC A62C 37/50; A62C 3/07; A62C 35/11; G01K 13/00

(57) ABSTRACT

A system, method, apparatus, and computer program product for testing a vehicle fire suppression system are disclosed. A method may include testing components of the vehicle fire suppression system. The method may additionally include providing test results for each tested component.

### FIELD OF THE DISCLOSURE

Aspects of the disclosure relate to vehicle fire suppression systems and, more particularly, to a system, method, apparatus, and computer program product for testing a vehicle fire suppression system.

### BACKGROUND

High value, high liability vehicles are critical to continued business operation in a variety of industries. As such, maintaining the vehicles in proper operating condition and ensuring the safety of vehicle operators and other occupants from the threat of fire are of paramount concern. For example, the use of buses and other transit vehicles in the public transit sector is critical to maintaining operation of a public transit system, and operators of public transit vehicles are tasked with ensuring that appropriate measures are in place to protect transit vehicle operators and passengers from the risks of fire. Further, industries, such as forestry, mining, waste management, and the military, use a variety of highly specialized vehicles. Given the cost (often exceeding $600,000) and specialization of these vehicles, businesses often do not have sufficient redundancy in their vehicle fleets to cover in the event of a prolonged maintenance issue or destruction of a vehicle. Moreover, the hazardous environments in which such vehicles are operated can increase the risk of vehicle fire.

Detection and suppression of fires in vehicles can pose a variety of challenges. For example, transit vehicles and other fleet vehicles often use Alternative Fuels, such as compressed natural gas (CNG), liquid natural gas (LNG), Propane and Hydrogen, which present a different fire risk than traditional fuels, such as gasoline and Diesel. In the case of transit buses, fire hazard areas, such as the engine, electrical system, and fuel storage, are located in the rear of the vehicle, making it difficult, if not impossible, for the driver to monitor for a potential fire. Mining vehicles present another hazard, as the vehicle operator may be seated two stories or more above the ground. As such, a vehicle fire in a mining vehicle has the potential to block the operator's exit from the vehicle. Vehicle engine compartments are often densely packed with hoses, mechanical and electrical components. Access to a fire, if one should occur, is extremely difficult. The proximity of components emitting a large amount of heat, such as turbochargers, exhaust systems, high output alternators, and the like, to fuel sources (e.g., hydraulic fluid, waste paper, forestry debris, etc.) has the potential to ignite and rapidly consume a vehicle before outside assistance can arrive.

As a result of the unique fire hazard that vehicles present, automatic fire detection and suppression systems, known as vehicle fire suppression systems, or automatic fire extinguishing systems (AFES), have been developed and implemented in many vehicles. Approval of a vehicle fire suppression system can be conducted by an insurance provider, such as Factory Mutual (FM), in accordance with guidelines issued by entities such as, the National Fire Protection Association (NFPA), Society of Automotive Engineers (SAE), the European Union (CE), and/or the like.

Vehicle fire suppression systems are complex systems, which include a variety of components to support fire detection and suppression. Moreover there are high liability risks attendant to vehicle safety systems. As such, regular inspection and maintenance of vehicle fire suppression systems is critical to ensure that the systems continue to comply with any applicable regulations and are in operative condition to protect vehicles and vehicle occupants.

While many vehicle fire suppression systems provide simple status indicators that indicate whether a system is “OK” or “Operating Normally” (e.g., as can be indicated by a green status light) or that there is a problem (e.g., a “Trouble” or “Fault” condition) with a system (e.g., as can be indicated by a yellow and/or red status light), current vehicle fire suppression systems do not provide any test functionality that provides particular status information for individual components of the system that can be used to identify the source of any problems or potential problems with the system. As such, maintenance and inspection of vehicle fire suppression systems is currently performed through manual inspections by trained technicians, known as fire suppression specialists. Fire suppression specialists are generally trained and certified by a vehicle fire suppression system manufacturer to maintain that specific manufacturer's system(s). From a liability standpoint, a fire suppression specialist is most often employed by a local fire suppression system distributor.

Inspection and maintenance requirements vary by manufacturer, but due to the high liability involved, the scheduled inspections can be frequent and time consuming. Moreover, given the highly specialized training that fire suppression specialists receive, service visits can be quite expensive. The high cost of vehicle fire suppression system maintenance can have a particularly high impact on public transit properties, which are often subsidized by Federal, State, and/or Local governments, as reduced tax revenue and budget cuts have placed a squeeze on budgets for maintaining vehicle fleets.

### SUMMARY

A system, method, apparatus, and computer program product for testing a vehicle fire suppression system are disclosed. For example, some embodiments provide for performance of an automated maintenance test, by which each of a plurality of components of a vehicle fire suppression system may be tested via an automated, step-by-step test. Test results for each of the plurality of components may be provided based on the test such that a maintenance technician may identify any problems with the vehicle fire suppression system. In this regard, some example embodiments test individual components and/or groups of components of the vehicle fire suppression system and provide itemized results for each component and/or component group, rather than simply providing an overall system status. These itemized test results provide a snapshot of the status of components vehicle fire suppression system, which can be used to identify the specific component(s) which may be the source of any problem or potential problem with the vehicle fire suppression system. The automated nature of the test that may be performed by such example embodiments may enable a general vehicle technician and/or other individual that may not be a trained fire suppression system to perform at least some of the regular inspection duties for vehicle fire suppression systems, thereby reducing costs maintenance costs and promoting increased frequency of inspection. Moreover, the speed and simplicity of the test from the technician's perspective may enable a technician to test vehicle fire suppression systems on several vehicles in a fleet in the same amount of time that it would require a skilled fire suppression specialist to manually inspect a single system.

In a first embodiment, a method for testing a vehicle fire suppression system is provided. The method may include testing each of a plurality of components of the vehicle fire suppression system. The method may further include providing test results for each of the plurality of components.

In another embodiment, a control system for a vehicle fire suppression system is provided. The control system may include processing circuitry, which may be configured to cause the control system to test each of a plurality of components of the fire suppression system. The processing circuitry may be further configured to cause the control system to provide test results for each of the plurality of components.

In a further embodiment, a computer program product for testing a vehicle fire suppression system is provided. The computer program product may include at least one-non-transitory computer readable storage medium having program instructions stored thereon. When executed by at least one processor, the stored program instructions may cause the at least one processor to perform a method comprising testing each of a plurality of components of the vehicle fire suppression system; and providing test results for each of the plurality of components.

In another embodiment, a vehicle fire suppression system is provided. The vehicle fire suppression system may include an extinguishing agent delivery system. The extinguishing agent delivery system may include an extinguishing agent container and an actuator configured to trigger release of extinguishing agent from the extinguishing agent container. The vehicle fire suppression system may further include a plurality of fire detection sensors. The vehicle fire suppression system may additionally include a control system, which may be operatively coupled with the plurality of fire detection sensors and with the actuator. The control system may include processing circuitry, which may be configured to cause the control system to perform a test of at least one component of the extinguishing agent delivery system and the plurality of fire detection sensors. The processing circuitry may be further configured to cause the control system to provide test results for each of the at least one component of the extinguishing agent delivery system and for the plurality of fire detection sensors.

It will be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a vehicle fire suppression system in accordance with some example embodiments;

FIG. 2 illustrates implementation of a portion of a vehicle fire suppression system within a transit bus in accordance with some example embodiments;

FIG. 3 illustrates a block diagram of an apparatus that may be implemented on a control system for a vehicle fire suppression system in accordance with some example embodiments;

FIG. 4 illustrates an example control panel for a vehicle fire suppression system in accordance with some example embodiments;

FIG. 5 illustrates a flowchart according to an example method for testing a vehicle fire suppression system in accordance with some example embodiments; and

FIG. 6 illustrates a flowchart according to another example method for testing a vehicle fire suppression system in accordance with some example embodiments.

### DETAILED DESCRIPTION

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

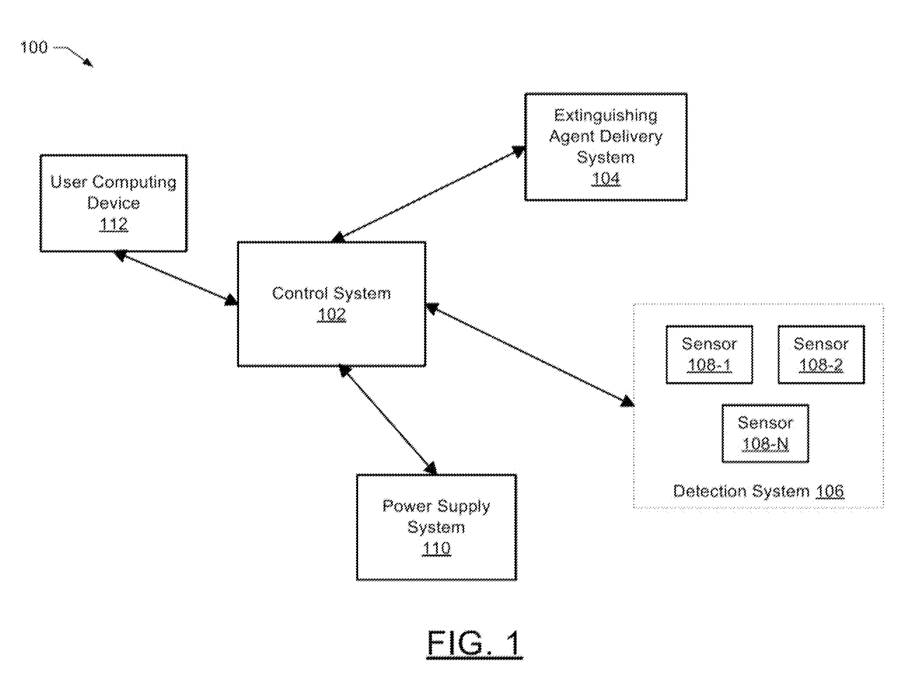

FIG. 1 illustrates a vehicle fire suppression system 100 in accordance with some example embodiments. The vehicle fire suppression system 100 may be implemented in a vehicle, such as a transit vehicle, forestry vehicle, mining vehicle, waste management vehicle, military vehicle, and/or the like. It will be appreciated, however, that various embodiments may be implemented within any vehicle that may include a vehicle fire suppression system. The vehicle fire suppression system 100 may include a control system 102, extinguishing agent delivery system 104, a detection system 106 including one or more fire detection sensors 108, and a power supply system 110. Various components of the vehicle fire suppression system 100 may be available from a fire suppression system manufacturer, such as, the Amerex Corporation. It will be appreciated, however, that the components, devices and elements illustrated in and described with respect to FIG. 1 not be mandatory and thus some may be omitted in certain embodiments. Additionally, some embodiments may include further or different components, devices or elements beyond those illustrated in and described with respect to FIG. 1.

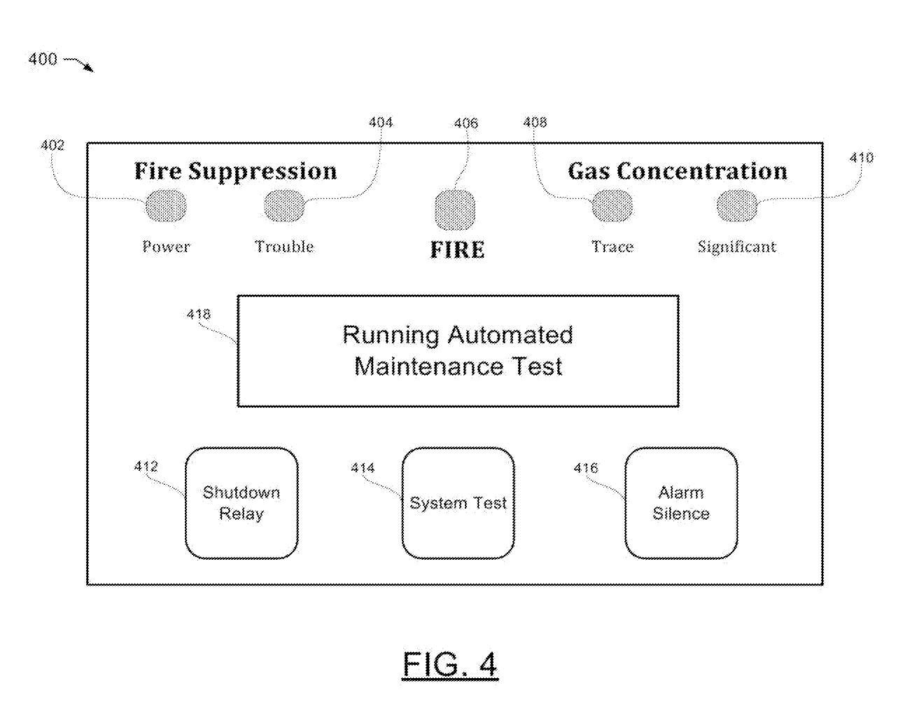

The control system 102 may comprise a computing device(s) and/or circuitry configured to control operation of the vehicle fire suppression system 100. The control system 102 may further provide a control interface including various user input and/or user output mechanisms to enable an operator to view system status and/or control the system. In some example embodiments, the control interface may comprise a control panel, such as that illustrated in and described below with respect to FIG. 4. As described further below, the control system 102 may be configured to cause release of extinguishing agent in the event of a fire. The control system 102 may additionally include a shutdown relay, which may be configured to disable vehicle operation in event of a fire, such as by cutting off the vehicle fuel supply. The shutdown relay may be embodied as any relay device(s) and/or any input/output device(s) capable of disabling vehicle operation. In some example embodiments, the control system 102 may be configured to perform data capture and event recording functionality to log conditions and events that may be detected via the detection system 106. The control system 102 of some example embodiments may be configured to perform a test each of a plurality of components of the vehicle fire suppression system 100 and provide test results in accordance with various example embodiments disclosed herein.

The extinguishing agent delivery system 104 may comprise one or more extinguishing agent containers. An extinguishing agent container may comprise a cylinder, modular generator, and/or other container, which may contain extinguishing agent. Extinguishing agent may be contained under pressure within an extinguishing agent container. Each extinguishing agent container may be operatively coupled with an actuator, which may be configured to trigger release of extinguishing agent from the extinguishing agent container. Any of a variety of actuation techniques may be implemented by an actuator, including, for example, pneumatic actuation, electrical actuation, and/or other suitable actuation technique that may be used to trigger release of extinguishing agent from an extinguishing agent container.

The actuator(s) may be operatively coupled with the control system 102 such that the control system 102 may control the actuator(s) to trigger release of extinguishing agent in event of a fire. For example, the control system 102 may be configured to automatically trigger release of extinguishing agent in response to detection of a fire via the detection system 106. As a further example, the control system 102 may provide an input mechanism enabling an operator to manually trigger release of extinguishing agent, and may be configured to trigger release of extinguishing agent in response to manual actuation of the input mechanism by an operator.

The extinguishing agent delivery system 104 may further include a system of one or more hoses and one or more nozzles coupled with the extinguishing agent container(s) to delivery extinguishing agent released from the extinguishing agent container(s) to areas of the vehicle in which a fire may occur. For example, nozzles may be positioned in the engine compartment, near a fuel tank, and/or in areas of the vehicle containing elements of the electrical system, fuel lines, and/or other areas that may be susceptible to fire. It will be appreciated that the number and locations of such hoses and nozzles may vary depending on the design of the vehicle and its application.

The detection system 106 may include one or more fire detection sensors 108, which are labeled as sensors 108-1 . . . 108-N in FIG. 1, and which are referred to hereinafter as sensors 108. A sensor 108 may comprise any sensor that may be configured to detect a condition that may be indicative of a fire. The detection system 106 and/or individual sensors 108 included in the detection system 106 may be operatively coupled with the control system 102 to enable the control system 102 to detect a fire based on sensory indications that may be provided by the sensors 108.

The detection system 106 may include any type or combination of multiple types of sensors 108 configured to detect a condition indicative of a fire. For example, in some embodiments, one or more sensors 108 may be embodied as a temperature sensor, which may be configured to measure a temperature in an area in which the temperature sensor is located. It will be appreciated that the temperature sensor may comprise any analog or digital sensor that may be configured to measure a temperature. In some example embodiments including a temperature sensor, the temperature sensor may be embodied as a programmable heat detector (PHD), such as a PHD available from the Amerex Corporation. Temperatures measured by a temperature sensor may be logged by the control system 102, such as in a memory that may be implemented on the control system 102. Additionally, a temperature sensor may have one or more programmable set point temperatures. If a temperature measured by the temperature sensor exceeds a programmed set point temperature, the control system 102 may be configured to log an event indicating that the set point was exceeded. Additionally or alternatively, if a temperature measured by the temperature sensor exceeds a programmed set point temperature, the control system 102 may be configured to determine that there is a fire condition and may be configured to sound an alarm indicative of a fire and/or trigger release of extinguishing agent via the extinguishing agent delivery system 104. It will be appreciated that in some embodiments, a temperature sensor may have multiple programmed set point temperatures. A first set point temperature may be a fire condition set point, for which if a measured temperature exceeds the first set point temperature, the control system 102 may determine that there is a fire condition. A second set point temperature may be a lower temperature than the first set point temperature, but that is a temperature exceeding a normal operating temperature range. The control system 102 may be configured to log an event indicating that the measured temperature is abnormally high to notify of a potential or impending problem in the event that the measured temperature exceeds the second set point temperature.

As another example, in some embodiments, one or more sensors 108 may be embodied as “detection circuits.” A detection circuit may, for example, comprise a specially configured linear wire that may be configured to change in characteristic in response to temperature reaching a particular set point such that a fire may be detected. For example, a detection circuit may be “open” when a temperature is below a set point, but may “close” in response to temperature reaching or exceeding the set point, or vice versa. As another example, a detection circuit may change in resistance in response to a change in temperature. As such, the control system 102 may be configured to monitor a detection circuit by monitoring continuity and/or resistance of the detection circuit. By way of non-limiting example, a detection circuit may be embodied as a “spot thermal sensor”, a “linear thermal normally open sensor”, or a “linear thermal resistive sensor,” as described further below.

A spot thermal sensor may have a temperature set point. The spot thermal sensor may be open in normal conditions, and may close when heated to its set point temperature. As such, when a spot thermal sensor closes, the control system 102 may be configured to determine that there is a fire condition, and may be configured to sound an alarm indicative of a fire and/or trigger release of extinguishing agent via the extinguishing agent delivery system 104. A spot thermal sensor may be self resetting, such that the spot thermal sensor may be configured to return to an open condition when the temperature cools below the set point temperature.

Linear thermal normally open sensors may be embodied as a specialized wire(s), which may be routed into a hazard area of a vehicle, such as the engine compartment and/or wheel well(s). In the event of a fire and/or excessive temperature condition, an insulating material on the linear thermal normally open sensor may melt and inner wires of the sensor may contact each other, thereby closing the circuit. When the circuit closes as a result of the insulating material melting, the control system 102 may be configured to determine that there is a fire condition, and may be configured to sound an alarm indicative of a fire and/or trigger release of extinguishing agent via the extinguishing agent delivery system 104. A linear thermal normally open sensor must be replaced in the event of a fire and/or other event that results in melting of the insulating material.

Linear thermal resistive sensors may comprise a linear wire(s) that may change in resistance in response to a change in temperature. The control system 102 may be configured to determine a change in resistance versus temperature, and may be configured to determine that there is a fire condition in an instance in which a measured resistance reaches a set point associated with a particular temperature. A linear thermal resistive sensor may be self resetting, as the resistance may return to a “normal” range in response to a decrease in temperature.

As a further example, in some embodiments, one or more sensors 108 may be embodied as “optical flame sensors.” An optical flame sensor may be configured to optically detect the presence of a fire. In this regard, an optical flame sensor may be configured to discriminate between an actual fire and other hot bodies/objects on a vehicle. It will be appreciated that an optical flame sensor may use any optical detection technology. For example, an optical flame sensor may comprise an ultraviolet light sensor, visible light sensor, near infrared sensor, wideband infrared sensor, and/or the like. If an optical flame sensor detects a fire, the control system 102 may be configured to determine that there is a fire condition and may be configured to sound an alarm indicative of a fire and/or trigger release of extinguishing agent via the extinguishing agent delivery system 104.

As an additional example, in some embodiments, one or more sensors 108 may be embodied as “combustible gas sensors.” Combustible gas sensors may be configured to detect the presence of potentially dangerous levels of combustible gases, such as alternative fuel gases (e.g., CNG. LNG, propane, hydrogen, and/or the like). The control system 102 may be configured to provide an indication (e.g., via an indicator light, audible alarm, and/or the like) if a combustible gas sensor detects a trace and/or significant (e.g., dangerous) amount of gas. In some embodiments, the control system 102 may be configured to disable vehicle operation, such as via a shutdown relay that may be implemented on the fire suppression system 100, in response to detection of more than a threshold amount of gas.

It will be appreciated that the foregoing examples of types of fire detection sensors that may be included in the vehicle fire suppression system 100 are provided by way of example, and not by way of limitation. In this regard, a sensor 108 may include any type of sensor that may be configured to detect a condition indicative of a fire. Further, it will be appreciated that the number of sensors 108 and the selection of type(s) of sensors 108 that may be implemented in the vehicle fire suppression system 100 may vary based on the design and application of a vehicle on which the vehicle fire suppression system 100 may be implemented.

Sensors 108 may be placed in any of a variety of fire hazard areas on a vehicle. As such, the placement locations of sensors 108 on a given vehicle may depend at least in part on the design of the vehicle and an application for which the vehicle is used. For example, combustible gas sensors may be placed near fuel storage tanks and/or fuel lines. As a further example, detection circuits, such as linear thermal normally open sensors and/or linear thermal resistive may be routed along electrical system wires and/or may be placed in other hazard areas, such as in wheel wells, near brake components, in the engine compartment, and/or the like. Temperature sensors, detection circuits, and/or other fire detection sensors that may be configured to detect dangerously high temperature conditions may be placed near high components emitting a large amount of heat, such as turbochargers, exhaust systems, high output alternators, and/or the like. As an additional example, sensors 108 may be placed in areas of a vehicle where combustible waste material, such as forestry debris, coal dust, and/or the like, may collect from usage of the vehicle.

The vehicle fire suppression system 100 may further include a power supply system 110. The power supply system 110 may be configured to provide power to enable operation of the fire suppression system 100. For example, the power supply system 110 may include a power supply that may use power from a primary vehicle power source, such as a vehicle battery, alternator, and/or the like. The power supply system 110 may additionally or alternatively include a dedicated battery (or batteries) that may be used solely for purposes of providing power to the vehicle fire suppression system 100 and/or for providing backup power to the vehicle fire suppression system 100 in the event of failure of a primary power source.

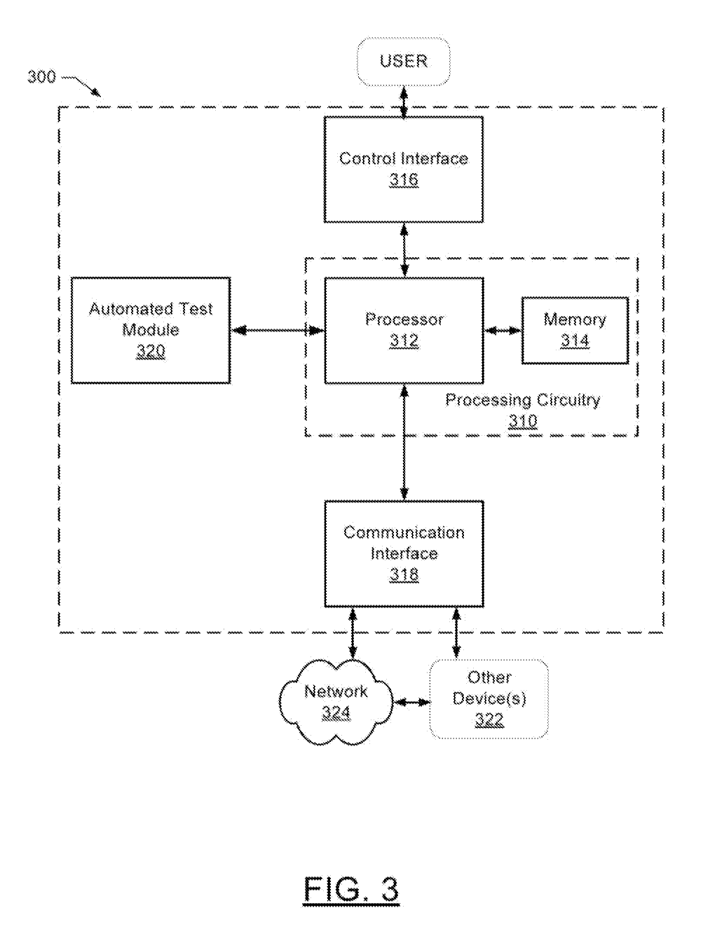

In some example embodiments, control system 102 may include a communication interface, such as the communication interface 318 illustrated in and described below with respect to FIG. 3, which may support communication to a user computing device 112, which may be external to the vehicle fire suppression system 100. The user computing device 112 may comprise any computing device that may be used by a user and that may be configured to communicate with the control system 102 via a direct connection (e.g., a wired and/or wireless connection) with the control system 102 and/or via an indirect connection via a network which may be accessed by both the control system 102 and the user computing device 112 of some example embodiments, By way of non-limiting example, the user computing device 112 may be embodied as a personal computer (e.g., desktop computer, laptop computer, or other personal computer), a mobile computing device (e.g., a smart phone, tablet computer, some combination thereof, or other mobile computing device), or the like.

In embodiments in which the user computing device 112 may communicate with the control system 102 via a direct wired connection, the wired connection may, for example, be provided via a Universal Serial Bus (USB) connection, FireWire connection, Thunderbolt connection, Ethernet connection, serial connection, RS-485 connection, a vehicle bus connection, such as a controller area network (CAN) connection or local interconnect network (LIN) connection, and/or the like. In embodiments, in which the user computing device 112 and control system 102 may communicate via a direct wireless connection, the wireless connection may be supported by any wireless communications technology that may be used to support communication between two devices within sufficient proximity of each other, including, for example, a wireless local area network (WLAN) technology, such as Wi-Fi and/or other WLAN technology that may conform to an Institute of Electrical and Electronics Engineers (IEEE) 802.11 standard; Wi-Fi direct; a wireless personal area network (WPAN) technology, such as various technologies based on the IEEE 802.15 standard (e.g., Bluetooth, Zigbee, and/or the like); Wireless USB; infrared (IR); near field communication (NFC); and/or other wireless communications technology.

In embodiments, in which the user computing device 112 may communicate with the control system 102 via an indirect connection via a network, a communication interface (e.g., communication interface 318 illustrated in and described below with respect to FIG. 3) may be configured to access a network. For example, in some embodiments, the control system 102 may be configured to access a cellular network, WiMAX network and/or other metropolitan network, and/or other access network, which may provide access to the Internet and/or other wide area network (WAN), which the user computing device 112 may also be capable of accessing.

The user computing device 112 may interface with the control system 102 to access data that may be maintained and/or otherwise provided by the control system 102. For example, the user computing device 112 may be used to access test results of tests of the vehicle fire suppression system 100 that may be performed in accordance with various example embodiments. As a further example, the user computing device 112 may be used to access various data that may be captured and maintained by the control system 102 in some example embodiments, such as logged event information, information regarding conditions detected by sensors 108 and/or operating information for the vehicle fire suppression system 100 that may be captured and maintained by the control system 102 in accordance with various embodiments.

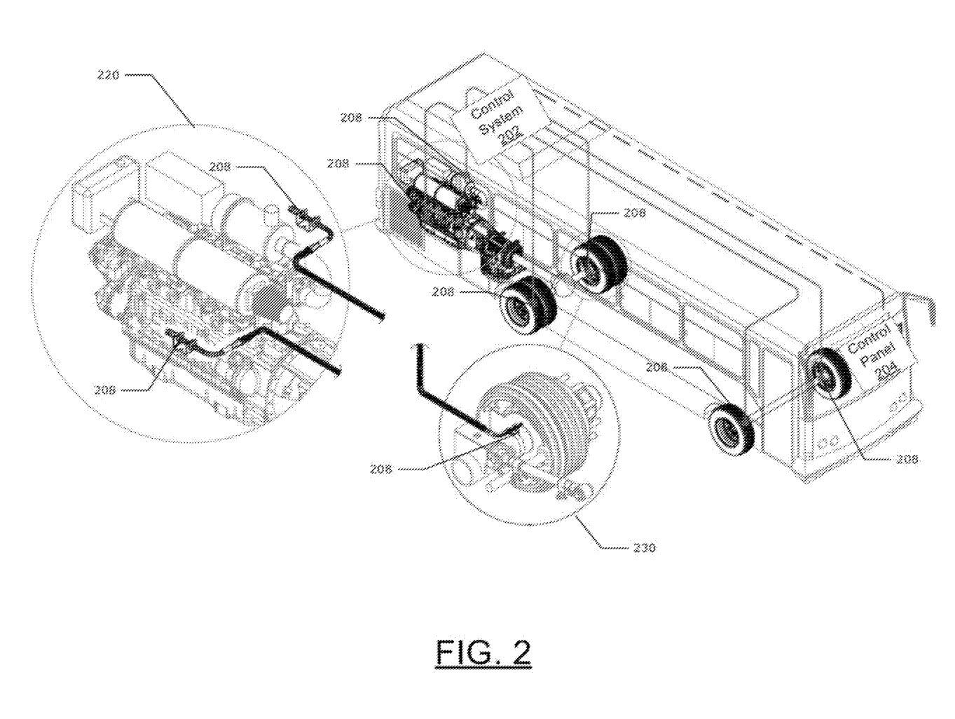

FIG. 2 illustrates an example implementation of a portion of a vehicle fire suppression system, such as vehicle fire suppression system 100, within a transit bus in accordance with some example embodiments. The example vehicle fire suppression system implemented in the transit bus may include a control system 202, which may comprise an embodiment of the control system 102. The control system 202 may include and/or be in operative communication with a control panel 204, which may provide a user interface enabling a user to control, view alerts provided by, and/or otherwise interact with the vehicle fire suppression system. The control panel 204 may, for example, include aspects of the control interface 316 illustrated in FIG. 3 and described further herein below, and, in some example embodiments, may comprise the control panel 400 illustrated in FIG. 4 and described further herein below.

The control system 202 may be further in operative communication with elements of a detection system, including a plurality of fire detection sensors 208, which may comprise respective embodiments of fire detection sensors 108. For example, in some embodiments, one or more of the fire detection sensors 208 may be embodied as programmable heat detectors and/or other type of temperature sensors. The fire detection sensors 208 may be deployed within hazard areas of the transit bus, such as the engine compartment and the wheel wells. For example, the detailed view 220 illustrates an example implementation of two fire detection sensors 208 within an engine compartment. The detailed view 230 similarly illustrates an example implementation of a fire detection sensor within a wheel well near a brake component that may overheat and pose a fire risk during operation.

FIG. 3 illustrates a block diagram of an apparatus that may be implemented on a control system (e.g., control system 102) for a vehicle fire suppression system, such as vehicle fire suppression system 100, in accordance with some example embodiments. It will be appreciated that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3.

In some example embodiments, the apparatus 300 may include processing circuitry 310 that is configurable to perform and/or control performance of functions of the control system 102 in accordance with one or more example embodiments disclosed herein. Thus, the processing circuitry 310 may be configured to perform data processing, application execution and/or other processing and management services that may be implemented to perform functionality of the control system 102 according to one or more example embodiments.

In some embodiments, the apparatus 300 or a portion(s) or component(s) thereof, such as the processing circuitry 310, may include one or more chipsets, which may each include one or more chips. The processing circuitry 310 and/or one or more further components of the apparatus 300 may therefore, in some instances, be configured to implement an embodiment on a chipset.

In some example embodiments, the processing circuitry 310 may include a processor 312 and, in some embodiments, such as that illustrated in FIG. 3, may further include a memory 314. The processing circuitry 310 may be in communication with or otherwise control a control interface 316, communication interface 318, and/or automated test module 320.

The processor 312 may be embodied in a variety of forms. For example, the processor 312 may be embodied as various hardware-based processing means, such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 312 may comprise a plurality of processors. The plurality of processors may be in operative communication with each other and may be collectively configured to perform one or more functionalities of the control system 102. In some example embodiments, the processor 312 may be configured to execute instructions that may be stored in the memory 314 and/or that may be otherwise accessible to the processor 312. As such, whether configured by hardware or by a combination of hardware and software, the processor 312 may be capable of performing operations according to various embodiments while configured accordingly.

In some example embodiments, the memory 314 may include one or more memory devices. Memory 314 may include fixed and/or removable memory devices. In some embodiments, the memory 314 may provide a non-transitory computer-readable storage medium that may store computer program instructions that may be executed by the processor 312. In this regard, the memory 314 may be configured to store information, data, applications, instructions and/or the like for enabling the apparatus 300 to carry out various functions of the control system 102 in accordance with one or more example embodiments. In some embodiments, memory 314 may be configured to at least temporarily store logs of test results from tests of the vehicle fire suppression system 100 that may be performed in accordance with various embodiments, events that may be recorded based on conditions detected by the sensors 108 and/or other component(s) of the detection system 106, information regarding conditions detected by sensors 108, and/or other operating information for the vehicle fire suppression system 100 that may be captured and maintained by the control system 102 in accordance with various embodiments. In some embodiments, the memory 314 may be in communication with one or more of the processor 312, control interface 316, communication interface 318, or automated test module 320 via a bus (or buses) for passing information among components of the apparatus 300.

In some example embodiments, the apparatus 300 may further include the control interface 316. The control interface 316 may provide a user interface configured to enable user interaction with and control of the vehicle fire suppression system 100. The control interface 316 may be in communication with the processing circuitry 310 to receive an indication of a user input and/or to provide an audible, visual, mechanical, or other output to a user. As such, the control interface 316 may include, for example, a keyboard, a keypad, one or more buttons, one or more switches, a display(s), a touch screen display(s), a microphone, a speaker, one or more indicator lights, and/or other input/output mechanisms. For example, the control interface 316 may include one or more status indicator lights, such as light emitting diodes (LEDs), which may be configured to provide status indications for the vehicle fire suppression system 100. As a further example, the control interface 316 may comprise a manual trigger for activating/deactivating a shutdown relay that may be used to disable vehicle operation, such as in event of a fire. The shutdown relay may be embodied as any relay device(s) and/or any input/output device(s) capable of disabling vehicle operation. As an additional example, the control interface 316 may include an input that may be used to silence an audible alarm. As another example, the control interface 316 may include an input that may be used to manually trigger release of extinguishing agent via the extinguishing agent delivery system 104. As still a further example, the control interface 316 may include an input that may be used to trigger performance of a test of the vehicle fire suppression system 100 in accordance with various embodiments. In some example embodiments, at least some elements of the control interface 316 may be implemented on a control panel, such as that illustrated in and described below with respect to FIG. 4.

The apparatus 300 may further include a communication interface 318. The communication interface 318 may enable the apparatus 300 to communicate with one or more further computing devices 322, either directly, or via a network 324. The network 324 may, for example, comprise a local area network, a metropolitan area network, a cellular network, and/or a wide area network, such as the internet. The device(s) 322 may, for example, comprise a user computing device 112. The communication interface 318 may accordingly include one or more interface mechanisms, such as an antenna (or multiple antennas) and supporting hardware and/or software for enabling communications via wireless communication technology (e.g., a cellular technology, communication technology, Wi-Fi and/or other IEEE 802.11 technology, Bluetooth, Zigbee, wireless USB, NFC, RF-ID, WiMAX and/or other IEEE 802.16 technology, and/or other wireless communication technology) and/or a communication modem or other hardware/software for supporting communication via cable, digital subscriber line (DSL), USB, FireWire, Thunderbolt, Ethernet, one or more optical transmission technologies, and/or other wireline communication methods. In some example embodiments in which the communication interface 318 is configured to support communication with a device, such as user computing device 112 via a direct wired connection, the communication interface 318 may include one or more ports/connectors supporting connection of a connecting cable capable of interconnecting with a computing device and/or supporting a direct connection to a corresponding port of a computing device. By way of non-limiting example, the communication interface may include one or more ports and/or connectors supporting connection via USB, FireWire, Thunderbolt, Ethernet, serial connection, RS-485, a vehicle bus connection, such CAN, LIN, and/or the like, some combination thereof, or the like.

The apparatus 300 may additionally include the automated test module 320. The automated test module 320 may be embodied as various means, such as circuitry, hardware, a computer program product comprising a computer readable medium (for example, the memory 314) storing computer readable program instructions that are executable by a processing device (for example, the processor 312), or some combination thereof. In some embodiments, the processor 312 (or the processing circuitry 310) may include, or otherwise control the automated test module 320. The automated test module 320 may be configured to control and/or otherwise perform a test of the vehicle fire suppression system 110 in accordance with various embodiments disclosed herein.

FIG. 4 illustrates an example control panel 400 for a vehicle fire suppression system, such as vehicle fire suppression system 100, in accordance with some example embodiments. The control panel 400 of some example embodiments may comprise input/output mechanisms that may be provided by the control interface 316. The control panel 400 may provide elements specified by guidelines that may be issued by a regulatory authority, such as the NFPA, an insurance provider, such as Factory Mutual, and/or other authority that may provide specifications for a vehicle fire suppression system.

The control panel 400 may include a plurality of status indicator lights (e.g., LEDs), such as status indicator lights 402-410, which may provide status indications for the vehicle fire suppression system 100. The status indicator light 402 may provide an indication of whether system power is being provided (e.g., by the power supply system 110) to the vehicle fire suppression system 100. The status indicator light 402 may additionally or alternatively serve to provide an indication that system operating conditions for the vehicle fire suppression system 100 are normal when illuminated. In some embodiments, the status indicator light 402 may be a green light. The status indicator light 404 may be a yellow light, which may be illuminated if there is trouble with the vehicle fire suppression system 100. The status indicator light 406 may be a red light, which may be illuminated if a fire has been detected. The status indicator lights 408 and 410 may be illuminated if gas has been detected (e.g., via a combustible gas sensor that may be included in the detection system 106). If a trace amount of gas has been detected, the status indicator light 408 may be illuminated. The status indicator light 408 may, for example, be a yellow light. If a significant amount of gas has been detected, the indicator light 410 may be illuminated. The status indicator light 410 may, for example, be a red light.

The control panel 400 may further include one or more user input mechanisms, such as the input mechanisms 412-416. Each input mechanism may, for example, be embodied as a key, button, switch, a selectable input that may be displayed on a touch screen display, and/or other input that may be manually actuated by a user. The shutdown relay switch 412 may comprise an input that may be used by a user to trigger activation and/or deactivation of a shutdown relay that may be used to disable vehicle operation. The system test button 414 may be used by a user to initiate performance of an automated maintenance test that may be performed in accordance with various embodiments disclosed herein. In this regard, the system test button 414 may enable invocation of a “push-to-test” functionality for testing the vehicle fire suppression system 100. The alarm silence button 416 may be used to silence an audible alarm that may be sounded if a fire is detected and/or during a test of the vehicle fire suppression system 100.

The control panel 400 may further include one or more displays, such as the display 418. The display 418 of some example embodiments may be configured to display operational status information for the vehicle fire suppression system 100. The display 418 may be additionally or alternatively configured to display test status information during a test of the vehicle fire suppression system 100, such as may be initiated by actuation of the system test button 414. For example, in the illustration of FIG. 4, the display 418 may display “Running Automated Maintenance Test” during at least a portion of the test. The display 418 may additionally or alternatively display an indication (e.g., a real time indication) identifying a component and/or component group being tested during the test so as to provide a user with an indication of the progress of the automated test. The display 418 may further display an operational status for each of one or more components, as may be ascertained during a test. The operational status for a component may indicate whether the component is functioning properly, or if there is an error with the component. The operational status for a sensor 108 may include a condition, such as a temperature, that may be measured and/or otherwise observed by the sensor. In some example embodiments, performance of the test may include aspects that may include prompts for a user to provide input confirming that a component is operational via a user input mechanisms, such as the input mechanisms 412-416. In such example embodiments, a prompt for the user to provide such input may be displayed on the display 418.

The control panel 400 may additionally include one or more navigational inputs (not illustrated), such as keys, buttons, and/or the like, which may be used to scroll and/or otherwise navigate information that may be displayed on the display 418. For example, test results may be displayed during and/or following performance of a test (e.g., in response to actuation of the system test button 414), and a user may use the navigational inputs to scroll through the results.

Having described several aspects of a vehicle fire suppression system and control panel therefore in accordance with various embodiments, aspects of the test of a vehicle fire suppression system, such as the vehicle fire suppression system 100, which may be performed in accordance with various example embodiments (e.g., by automated test module 320) will now be described. In accordance with some example embodiments, a user may initiate performance of a test of the vehicle fire suppression system 100 via actuation of an input, such as the system test button 414, which may be provided by the control interface 316. The automated test module 320 may be configured to initiate performance of a test of the vehicle fire suppression system 100 in response to actuation of the input.

The automated test module 320 may be configured to test each of a plurality of components of the vehicle fire suppression system 100. The automated test module 320 may be further configured to provide test results for each of the plurality of components. The test results may be itemized by component and/or by component group for a group of components that may be grouped based on type, as described further below.

In some example embodiments, the test results for a component may include an operational status for the component. For example, the operational status for a component may include a value, such as a temperature, pressure, voltage, resistance, and/or the like, that may be associated with and/or output by the component and that may be measured by and/or otherwise determined by the automated test module 320. Additionally or alternatively, the operational status for a component may comprise an indication that the component is operating properly (e.g., “OK”) or that the component is not operating properly (e.g., “Fault Detected”).

In some example embodiments, the test results may be provided at least in part by displaying at least a portion of the test results on a display, such as display 418, which may be provided by the control interface 316. Additionally or alternatively, in some embodiments, the automated test module 320 may be configured to provide the test results by generating a log comprising the test results. The log may comprise an itemized listing of test results for each tested component and/or component group. In some example embodiments, the log may be formatted as a file, such as a .txt file, a document file that may be opened in a word processing program, a worksheet file that may be opened in a spreadsheet program and/or other file, a file that may be opened in a database program, and/or other file format.

In some example embodiments, the test results may be stored on a memory (e.g., memory 314) that may be implemented on the control system 102. The stored test results may be maintained as part of the vehicle history. The user computing device 112 may access and download the stored test results.

Additionally or alternatively, in some embodiments, the automated test module 320 may be configured to automatically export the test results (e.g., via the communication interface 318) to the user computing device 112 and/or other computing device that may be communicatively coupled with the control system 102. As a further example, in some embodiments, test results may be sent via a wide area network that may be accessed by the control system 102 to a manufacturer of the vehicle fire suppression system 100, a distributor of the vehicle fire suppression system 100, a regulatory authority responsible for certifying proper operation of the vehicle fire suppression system 100, an insurance provider that may provide insurance for a vehicle on which the vehicle fire suppression system 100 may be implemented, and/or other entity.

In some example embodiments, a user initiating the test may provide his or her name and/or other identifier, such as an employee ID number, for entry into a log of test results. For example, the user's name and/or other identifier may be entered by the user via the control interface 316 prior to and/or during performance of the test. Additionally or alternatively, as another example, the user may enter his or her name and/or other identifier via the user computing device 112 for addition to a log of the test results after performance of the test. In some embodiments, an identifier associated with the vehicle may also be included in a log of the test results. The vehicle identifier may be manually entered via the user and/or may be known to the automate test module 320 and may be automatically inserted in the test results by the automated test module 320.

In some example embodiments, a log of test results may include a time and/or date of the test. The test results may also show a logical organization of detected components of the vehicle fire suppression system. For example, the test results may identify the ports/modules of the control system 102 to which respective sensors 108 and/or other components of the vehicle fire suppression system 102 may be connected.

As described above, in some example embodiments, components of the vehicle fire suppression system may be categorized into logical component groups based at least in part on component type. Each component group may include at least one component. For example, in some embodiments, the sensors 108 may be grouped into a single group. Additionally or alternatively, in some embodiments, the sensors 108 may be grouped into groups by sensor type, such as a group or one or more temperature sensors, a group of one or more optical flame sensors, a group of one or more combustible gas sensors, a group of one or more detection circuits, and/or the like. Further example component group types may include a group of one or more status indicator lights, a group of one or more extinguishing agent containers, a group of one or more power supplies, and/or other types of components that may be implemented in the vehicle fire suppression system 100 and grouped by type.

The automated test module 320 may be configured to sequentially test each component group when performing a test. For example, all components in a first component group may be tested before beginning to test components in a second component group, and so on until all component groups have been tested. The automated test module 320 may be configured to provide test results (e.g., itemized test results) for each component group that is tested. In some example embodiments, the test results for a component group may include an operational status for each of at least one individual component in the component group and/or for the component group as a whole. Additionally or alternatively, in some example embodiments, the test results for a component group may comprise a count of a number of detected functional components in the respective component group. For example, a count of a number of sensors 108 of each sensor type (e.g., temperature sensors, detection circuits, optical flame sensors, combustible gas sensors, and/or other type) that may be implemented in the vehicle fire suppression system 100 may be provided in the test results. A listing of operational components detected by the automated test module 320 by type and count may be used to verify that each component of the vehicle fire suppression system 100 believed to be installed in the vehicle has been detected by the automated test module 320 and is operating properly and/or to verify that the components of the vehicle fire suppression system 100 satisfy vehicle specifications (e.g., as may be specified by a vehicle manufacturer, vehicle operator, insurance provider, regulatory authority, and/or other entity).

It will be appreciated that the components that may be tested by the automated test module 320 may vary depending on the components included in the vehicle fire suppression system 100. For example, the automated test module 320 may be configured to test operation of individual sensors 108 and/or individual groups of sensors 108. For example, the automated test module 320 may test for presence of the sensors 108. If a sensor cannot be found or is otherwise diagnosed as having a fault, the test results may indicate that a sensor fault has been found in the test results.

In embodiments in which the sensors 108 comprise one or more temperature sensors, a temperature sensor may be tested by verifying that the temperature sensor is operable and/or by determining at least one temperature measured by the temperature sensor. For example, the testing may include determining one or more of a temperature measured by the temperature sensor during the test, a maximum temperature measured by the temperature sensor over a period of time preceding the test (e.g., since performance of the last test), or a minimum temperature measured by the temperature sensor over a period of time preceding the test (e.g., since performance of the last test). In some example embodiments, the test results may include a time and/or date at which the maximum/minimum temperature was recorded. The maximum and minimum temperatures may aid a technician in identifying maintenance issues before a component failure or fire occurs. For example, if a maximum/minimum temperature measured by a temperature sensor is outside of a normal operating range for the temperature sensor's location, but is not at a set point configured to trigger a fault or fire alert, the abnormal temperature may be an indication that a vehicle component is failing and/or otherwise is in need of inspection and/or maintenance. As a particular example, a programmable heat detector positioned near a turbocharger known to operate at around 405 degrees Fahrenheit may be programmed with a set point of 550 degrees Fahrenheit for triggering a fire alarm. If a maximum temperature recorded by the programmable heat detector is 500 degrees Fahrenheit, a technician may diagnose that there is a potential problem with the turbocharger based on the search results including the maximum temperature.

In embodiments in which the sensors 108 comprise one or more detection circuits, the automated test module 320 may be configured to check the continuity and/or resistance of a detection circuit to verify proper operation of the detection circuit.

In some example embodiments, the automated test module 320 may be configured to test operation of status indicator lights, such as such as indicator lights 402-410, that may be implemented by the control interface 316. For example, in some embodiments each status indicator light may be activated (e.g., concurrently or in sequence one at a time) to test operation of the status indicator light(s). In some example embodiments, the automated test module 320 may be configured to autonomously determine whether the status indicator lights are properly functioning. Additionally or alternatively, in some embodiments, a technician or other user that may have initiated performance of the test may be prompted (e.g., via display 418) to confirm that all status indicator lights functioned properly when activated and/or indicate if a status indicator light failed to properly illuminate. For example, in some embodiments, a user may confirm that the status indicator lights are operating properly by actuating the system test button 414 in response to a prompt.

In some example embodiments, the automated test module 320 may be configured to test operation of a shutdown relay. For example, the shutdown relay may be engaged by the automated test module 320 to verify that the shutdown relay is working. In some example embodiments, a user may be prompted (e.g., via display 418) to reset the relay (e.g., via actuation of the shutdown relay switch 412. Additionally or alternatively, in some example embodiments, the shutdown relay may be automatically reset by the automated test module 320 (e.g., after a timeout period).

The automated test module 320 may be further configured to test components of the extinguishing agent delivery system 104. For example, the automated test module 320 may be configured to check that each of one or more extinguishing agent containers that may be included in the extinguishing agent delivery system 104 is properly pressurized. For example, in some embodiments, the automated test module 320 may be configured to measure an actual pressure of an extinguishing agent container. Additionally or alternatively, in some example embodiments, the automated test module 320 may be configured to verify that an extinguishing agent container is properly pressurized by testing a pressure switch circuit that may be operatively coupled with the extinguishing agent container. The test results that may be provided in some example embodiments may include an actually measured pressure for an extinguishing agent container. Additionally or alternatively, the test results of some example embodiments may provide an indication that an extinguishing agent container is properly pressurized (e.g., “Agent Cylinder OK”) or that the pressure in the extinguishing agent container is low (e.g., “Low Container Pressure”). In some example embodiments, the automated test module 320 may be further configured to test one or more actuators, such as an electrical actuation circuit, that may be implemented on the extinguishing agent delivery system 104 for triggering release of extinguishing agent.

The automated test module 320 may be additionally configured to test one or more components of the power supply system 110. For example, the automated test module 320 may be configured to measure and/or verify a voltage provided by a primary power supply. As a further example, the automated test module 320 may be configured to measure and/or verify a voltage provided by a backup battery. The test results that may be provided in some example embodiments may include an actually measured voltage of a primary power supply and/or of a backup battery. Additionally or alternatively, the test results of some example embodiments may provide an indication that a power supply (e.g., a primary power supply and/or backup battery) is operating properly (e.g., “OK”) or that that the power supply is not providing adequate power (e.g., “Low Battery”).

In some example embodiments, the automated test module 320 may be further configured to test one or more audible alarms that may be implemented on the vehicle fire suppression system 100. For example, in some such embodiments, the automated test module 320 may be configured to trigger an audible alarm. In some embodiments, the automated test module 320 may be configured to autonomously determine whether the audible alarm is properly functioning, such as by using a microphone to detect sound from the alarm. Additionally or alternatively, in some embodiments, a technician or other user that may have initiated performance of the test may be prompted (e.g., via display 418) to confirm that the alarm is properly functioning. For example, in some embodiments, a user may confirm that the alarm is operating properly by actuating the system test button 414 and/or an “alarm silence button” in response to a prompt. In embodiments in which the user may confirm alarm operating status, the alarm may be silenced in response to user actuation of an input. Additionally or alternatively, in some example embodiments, the alarm may be automatically silenced by the automated test module 320 (e.g., after a timeout period).

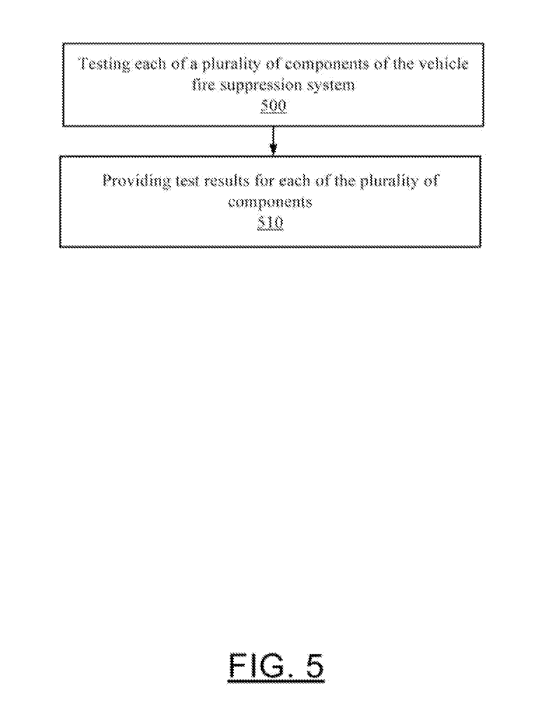

FIG. 5 illustrates a flowchart according to an example method for testing a vehicle fire suppression system, such as the vehicle fire suppression system 100, in accordance with some example embodiments. The operations illustrated in and described with respect to FIG. 5 may, for example, be performed by the control system 102. One or more of processing circuitry 310, processor 312, memory 314, control interface 316, communication interface 318, or automated test module 320 may, for example, provide means for performing one or more of the operations illustrated in and described with respect to FIG. 5. In some example embodiments, the method of FIG. 5 may be performed in response to user initiation of a test, such as via actuation of the system test button 414 and/or other input that may be provided by the control interface 316.

Operation 500 may include testing each of a plurality of components of the vehicle fire suppression system 100. Operation 500 may be performed in response to initiation of an automated maintenance test, such as via user (e.g., a system technician) actuation of the system test button 414 and/or other input that may be provided by the control interface 316.

Operation 510 may comprise providing test results for each of the plurality of components. In some example embodiments, operation 510 may include generating a log comprising the test results. The log may be saved to a memory of the vehicle fire suppression system 100 and/or may be exported to an external computing device, such as the user computing device 112. Additionally or alternatively, in some example embodiments, operation 510 may include displaying at least a portion of the test results on a display, such as a display of the control interface 316 (e.g., display 418) and/or a display of an external computing device, such as user computing device 112 that may be in communication with the control system 102.

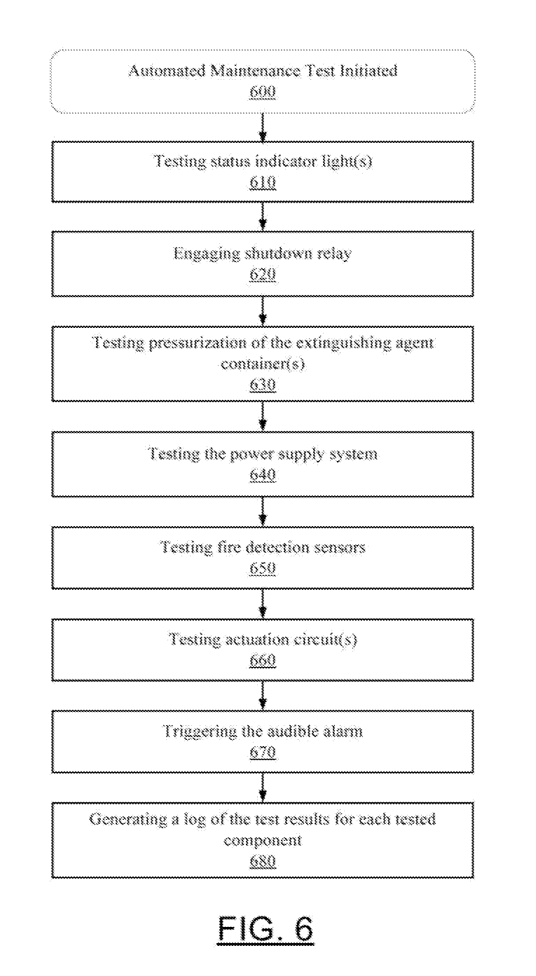

FIG. 6 illustrates a flowchart according to another example method for testing a vehicle fire suppression system, such as the vehicle fire suppression system 100, in accordance with some example embodiments. More particularly, FIG. 6 illustrates an example embodiment of the method of FIG. 5 including examples of components of the vehicle fire suppression system 100 that may be tested in accordance with some example embodiments. The operations illustrated in and described with respect to FIG. 6 may, for example, be performed by the control system 102. One or more of processing circuitry 310, processor 312, memory 314, control interface 316, communication interface 318, or automated test module 320 may, for example, provide means for performing one or more of the operations illustrated in and described with respect to FIG. 6.

As illustrated by operation 600, an automated maintenance test may be initiated. The automated maintenance test may, for example, be initiated in response to user (e.g., a system technician) actuation of the system test button 414 and/or other input that may be provided by the control interface 316. One or more of operations 610-680 may be performed in response to initiation of the automated maintenance test.

Operation 610 may comprise testing one or more status indicator lights, such as status indicator lights 402-410, that may be provided by the control interface 316. In some such embodiments, a status message may be displayed on a display of the control interface 316 to indicate which status indicator light is being tested.

As an example using the example control panel 400 of FIG. 4, the FIRE status indicator light 406 may be tested first. The display 418 may display “Fire LED Test,” and the status indicator light 406 may blink one or more (e.g., two) times and an audible alarm may be sounded one or more (e.g., two) times concurrently with the blinking of the status indicator light 406. The Power status indicator light 402 may then be tested. The display 418 may display “Power LED Test,” and the status indicator light 402 may blink one or more (e.g., two) times. The Trouble status indicator light 404 may then be tested. The display 418 may display “Trouble LED Test,” and the status indicator light 404 may blink one or more (e.g., two) times and an audible alarm may be sounded one or more (e.g., two) times concurrently with the blinking of the status indicator light 404. The Trace Gas Concentration status indicator light 408 may then be tested. The display 418 may display “Trace LED Test,” and the status indicator light 408 may blink one or more (e.g., two) times and an audible alarm may be sounded one or more (e.g., two) times concurrently with the blinking of the status indicator light 408. The Significant Gas Concentration status indicator light 410 may then be tested. The display 418 may display “Significant LED Test,” and the status indicator light 410 may blink one or more (e.g., two) times and an audible alarm may be sounded one or more (e.g., two) times concurrently with the blinking of the status indicator light 410.

In some example embodiments, the automated test module 320 may be configured to autonomously determine whether the status indicator lights are properly functioning. Additionally or alternatively, in some embodiments, a technician or other user that may have initiated performance of the test may be prompted (e.g., via display 418) to confirm that all status indicator lights functioned properly when activated and/or indicate if a status indicator light failed to properly illuminate. As an example using the control panel 400, a user may be prompted via display 418 to “Press System Test to Confirm LEDs OK.” If the status indicator lights 402-410 functioned properly during the test, the user may press the system test button 414 to confirm that they functioned properly. In some example embodiments, if the user does not provide input confirming status indicator light functionality within a timeout period (e.g., two minutes or other timeout period length), the method may continue with testing the next component. A log of the test results may note if no user input was provided to confirm that the status indicator lights functioned properly.

Operation 620 may include engaging the shutdown relay. In some example embodiments, a status message may be displayed on a display of the control interface 316 to indicate that the shutdown relay is being tested. As an example using the control panel 400, “Relay Test” may be displayed on the display 418, and an LED that may be associated with the shutdown relay may be illuminated.

In some example embodiments, the automated test module 320 may be configured to autonomously reset the shutdown relay without user input after engaging the shutdown relay. Additionally or alternatively, in some embodiments, a technician or other user that may have initiated performance of the test may be prompted (e.g., via display 418) to reset the shutdown relay. As an example using the control panel 400, a user may be prompted via display 418 to “Press RELAY RESET button,” and may reset the shutdown relay by actuating the shutdown relay switch 412 to reset the shutdown relay. The display 418 may then display “Relay Test Complete,” and an audible alarm may optionally be sounded one or more (e.g., five) times. In some example embodiments, if the user does not provide input resetting the shutdown relay within a timeout period (e.g., two minutes or other timeout period length), the method may continue with testing the next component. A log of the test results may note if no user input was provided to reset the shutdown relay.

Operation 630 may comprise testing pressurization of the extinguishing agent container(s) of the vehicle fire suppression system 100. In some example embodiments, a status message may be displayed on a display of the control interface 316 to indicate that the extinguishing agent container(s) is being tested. As an example using the control panel 400, “Testing Agent Cylinder(s)” may be displayed on the display 418, and an LED that may be associated with the shutdown relay may be illuminated. A result of the test may additionally be displayed. For example, the display 418 may display “Agent Cylinder(s) OK” if the cylinder pressure is normal, or may display “Low Cylinder Pressure. Service System” if the pressure in one or more extinguishing agent containers is low (e.g., if the measured pressure is less than a threshold pressure).

Operation 640 may include testing the power supply system. In some example embodiments, a status message may indicating that the power supply system is being tested and/or identifying a particular component thereof that is being tested may be displayed on a display of the control interface 316.

As an example using the control panel 400, the display 418 may, for example, display “Testing Power Input” when testing the primary power supply. The display 418 may additionally display the measured voltage provided by the primary power supply (e.g., “Power @ XX.X Volts DC). The display 418 may, for example, further display “Testing Back-Up Battery” when testing a backup power supply. The display 418 may additionally display the measured voltage provided by the backup power supply (e.g., “Battery @ X.X Volts DC).

Operation 650 may comprise testing the fire detection sensors. In some example embodiments, the fire detection sensors may be grouped and tested by sensor type. In some example embodiments, a status message may be displayed on a display of the control interface 316 to indicate which sensor and/or sensor type is being tested at a given time during performance of operation 650.

As an example using the control panel 400, any combustible gas sensors that may be implemented in the vehicle fire suppression system 100 may be tested attendant to performance of operation 600. The display 418 may, for example, display “Testing Gas Sensor(s).” The display 418 may further display the number of operable combustible gas sensors that are detected (e.g., “4 Gas Sensors Found”). If a fault is detected in one or more combustible gas sensors, the display 418 may, for example, display “Gas Sensor Fault Found.”

Operation 650 may additionally include testing any detection circuits that may be implemented in the vehicle fire suppression system 100. The display 418 may, for example, display “Testing Detection Circuit(s).” The display 418 may further display the number of operable detection circuits that are detected. If a fault is detected in one or more detection circuit, the display 418 may, for example, display “Detection Circuit Fault Found.”

Operation 650 may further include testing any programmable heat detectors (PHDs) and/or other temperature sensors that may be implemented in the vehicle fire suppression system 100. The display 418 may, for example, display “Testing PHD(s).” The display 418 may further display the number of operational temperature sensors that are detected (e.g., “4 PHDs OK”). If a fault is detected in one or more temperature sensors, the display 418 may, for example, display “PHD Fault Found-Service System.”

Operation 650 may further include recording, for each temperature sensor, a current temperature measured by the temperature sensor, a maximum temperature measured by the temperature sensor since the last test and/or other period of time preceding the current test, a minimum temperature measured by the temperature sensor since the last test and/or other period of time preceding the current test, and any alarm set point temperature(s) that may be associated with the temperature sensor. In some embodiments, such as some embodiments in which the minimum/maximum temperatures are minimum/maximum temperatures since the last test, the stored minimum/maximum temperatures may be erased such that new minimum/maximum temperatures may be recorded over a period extending until the next test.

In some example embodiments, the display 418 may display at least a portion of the temperatures (e.g., current, maximum, minimum, set point) that may be recorded in test results for each temperature sensor. The user may use navigational keys and/or other inputs to scroll through the temperature data on the display 418 if the data exceeds an amount of display space provided by the display 418. In some example embodiments, if the user has completed his or her review of the temperature data, the user may actuate an input, such as the system test button 414, to continue with testing of the next system component. For example, in some embodiments, the display 418 may display instructions, such as “Press System Test to Exit or Up/Down to Display Temperature Readings.” In some example embodiments, if the user does not actuate an input, such as the system test button 414, to continue testing prior to elapse of a timeout period (e.g., 10 minutes), the method may proceed with testing the next system component, and an indication that no operator input was received may be recorded in the test results.

Operation 660 may comprise testing the actuation circuit(s). In some example embodiments, a status message indicating that the actuation circuit(s) is being tested may be displayed on a display of the control interface 316. As an example using the control panel 400, the display 418 may display “Testing Actuation Circuit(s).” If no faults are found in the actuation circuit(s), the display 418 may display a message, such as “Actuation Circuit(s) OK.” If, however, a fault is found, the display 418 may display a message, such as “Actuation Circuit Fault Found.”

Operation 670 may comprise triggering the audible alarm. In some example embodiments, a status indicating that the alarm is being tested may be displayed on a display of the control interface 316. As an example using the control panel 400, the display 418 may display “Testing Audible Alarm.” In some embodiments, the automated test module 320 may be configured to autonomously determine whether the audible alarm is properly functioning. Additionally or alternatively, in some example embodiments, the alarm may sound until the user presses an input, such as the alarm silence button 416, to silence the alarm and/or until a timeout period elapses. In some such embodiments, if the user does not silence the alarm prior to expiration of the timeout period, an indication that the user die not confirm that the alarm was working by silencing the alarm may be indicated in the test results.

One or more of operations 610-670 may, for example, be performed attendant to performance of operation 500 in the example of FIG. 5. It will be appreciated that the ordering of operations 610-670 is provided by way of example, and not by way of limitation, as components and/or component groups may be tested in any order within the scope of disclosure. Further, in some example embodiments, testing of one or more component types may be omitted, such as in the case that a particular component type is not included on a given vehicle fire suppression system. Additionally, one or more further and/or alternative component types beyond those discussed by way of example with respect to operations 610-670 may be tested in accordance with some example embodiments (e.g., depending on the types of components included in a given vehicle fire suppression system).

Operation 680 may comprise generating a log of the test results for each tested component. In this regard, operation 680 may, for example, correspond to an embodiment of operation 510. In some example embodiments, operation 680 may be performed on an ongoing basis during testing of components (e.g., during performance of operations 610-670), as test results may be added to the log as they are determined. Alternatively, in some example embodiments, the test results may be aggregated and used to generate the log after completion of component testing (e.g., after completion of operation 670). The log may be stored to memory (e.g., memory 314) and/or may be exported to an external computing device, such as user computing device 112.

In some example embodiments, a status indication indicative of the test results may be displayed on a display of the control interface 316 following completion of the test. As an example using the control panel 400, the display 418 may display “Auto Test Complete-System OK” if the test did not find any faults. The vehicle fire suppression system 100 may further return to a normal operating mode after completion of the test, and a green status light, such as the power status indicator light 402, may be illuminated.

Alternatively, if a fault(s) was found, the display 418 may, for example, display “System Faults Found. Service System.” The trouble status indicator light 404 may also be illuminated.

An example log of test results that may be generated in accordance with some example embodiments, such as attendant to the performance of the method of FIG. 5 and/or the method of FIG. 6 is as follows:
Automated Maintenance Test System Diagnostic Report
Test Date: MM/DD/YYY 03:52:04 pm Vehicle ID: xxxx
Tested By: (your name here)
Last Self-Test: MM/DD/YYY 10:54:52 AM
Current System Status: Normal
Self-Test Results:
Modules Detected:
   Module 1: 16390 Driver
   Module 2: 17745 Brake Overheat
Sensors Detected:
   Module 1:
      Sensor 1 (Sensor Name?):: Programmable Heat Detector
      Sensor 2 (Sensor Name?):: Programmable Heat Detector
      Sensor 3 (Sensor Name?):: None
      Sensor 4 (Sensor Name?):: Gas Sensor
      Sensor 5 (Sensor Name?):: Spot Thermostat
      Sensor 6 (Sensor Name?):: Spot Thermostat
   Module 2:
      Sensor 1 (Sensor Name?):: Programmable Heat Detector
      Sensor 2 (Sensor Name?):: Programmable Heat Detector Sensor
      3 (Sensor Name?):: None
      Sensor 4 (Sensor Name?):: None
Operator Display Status:
   All LEDs: PASS
   Audible Alarm: PASS
   Alarm Silence Button: PASS
   Relay Reset Button: PASS
Module Status:
   Agent Cylinder Pressure: PASS
   Actuation Circuits: PASS
   Input Voltage: 28.2 VDC
   Backup Battery Voltage: 9.7 VDC
Optical Sensor Status:
   Module 2:
      Sensor 3:
         Ref: x.x VDC
         Alarm: x.x VDC
Gas Sensor Status:
   Module 1:
      Sensor 4:
         Vrl: 1.1 VDC
         Vcomp: 3.8 VDC
PHD Status:
   Module 1:
      Sensor 1:
         Minimum: 68 F at MM/DD/YYYY 10:54:59 AM
         Maximum: 76 F at MM/DD/YYYY 11:05:43 AM
         Alarm Set Point: xxxxx F
         Current: 72 F
      Sensor 2:
         Minimum: 72 F at MM/DD/YYYY 03:45:47 PM
         Maximum: 72 F at MM/DD/YYYY 03:45:47 PM
         Alarm Set Point: xxxxx F
         Current: 72 F
   Module 2:
      Sensor 1:
         Minimum: 69 F at MM/DD/YYYY 10:54:57 AM
         Maximum: 76 F at MM/DD/YYYY 03:44:46 PM
         Alarm Set Point: xxxxx F
         Current: 76 F
      Sensor 2:
         Minimum: 71 F at 08/05/2013 10:54:58 AM
         Maximum: 77 F at MM/DD/YYYY 03:45:03 PM
         Alarm Set Point: xxxxx F
         Current: 76 F

In some example embodiments, a single input device, such as the system test button 414, which may be provided by the control interface 316, may be used to trigger performance of multiple types of tests of the vehicle fire suppression system depending on a manner in which it is actuated. Accordingly, a user may select the type of test he or she wishes to perform based on a manner in which the user actuates the input device. For example, if the input device is actuated in a first manner (e.g., by pressing and holding the input device for a first duration, such as between 0 and 5 seconds), a general system test may be performed. The general system test may provide an indication that 1) the vehicle fire suppression system is operating properly; or 2) that there is a fault in the vehicle fire suppression system. The general system test may not include any of the component-specific testing or detailed test results that may be provided in accordance with the methods of FIGS. 5 and 6. If the input device is actuated in a second manner (e.g., by pressing and holding the input device for a second duration, such as between 5 and 10 seconds), operation of the shutdown relay may be tested. If the input device is actuated in a third manner (e.g., by pressing and holding the input device for a third duration, such as a period exceeding 10 seconds), an automated maintenance test, such as described with respect to FIGS. 5 and/or 6 may be performed. The automated maintenance test may include component-specific testing and test results in accordance with various embodiments described herein.

It will be understood that each block of the flowcharts in FIGS. 5-6, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which may embody the procedures described herein may be stored by one or more memory devices of a computing device, such as control system 102 and/or portion(s) thereof, and executed by a processor (e.g., processor 312) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s). Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

Moreover, it will be appreciated that the ordering of blocks and corresponding method operations within the flowchart is provided by way of non-limiting example in order to describe operations that may be performed in accordance some example embodiments. In this regard, it will be appreciated that the ordering of blocks and corresponding method operations illustrated in the flowchart is non-limiting, such that the ordering of two or more block illustrated in and described with respect to the flowchart may be changed and/or method operations associated with two or more blocks may be at least partially performed in parallel in accordance with some example embodiments. Further, in some embodiments, one or more blocks and corresponding method operations illustrated in and described with respect to the flowchart may be optional, and may be omitted.

Functions in accordance with the above described embodiments may be carried out in many ways. In this regard, any suitable means for carrying out each of the functions described above may be employed to carry out various embodiments. In some embodiments, a suitably configured processor (e.g., processor 312) may provide all or a portion of the elements. In other embodiments, all or a portion of the elements may be configured by and operate under control of a computer program product. The computer program product for performing the methods of various embodiments of includes at least one computer readable storage medium having computer readable program code stored thereon. The computer readable medium (or media) may, for example, be embodied as and/or otherwise include the memory 314. However, it will be appreciated that a computer program product in accordance with various example embodiments may include any data storage device (e.g., a non-transitory computer readable storage medium) that can store data, which can be thereafter read by a computer system. Examples of the computer readable storage media include hard drives, network attached storage (NAS), read-only memory, random-access memory, one or more digital versatile disc (DVDs), one or more compact disc read only memories (CD-ROMs), one or more compact disc-recordable discs (CD-Rs), one or more compact disc-rewritable discs (CD-RWs), one or more Blu-Ray discs, magnetic tapes, flash memory, some combination thereof, and/or other optical and non-optical data storage devices. Some example embodiments may additionally or alternatively use computer readable storage media distributed over a network coupled computer system such that the computer readable code may be stored and executed in a distributed fashion.

It will be appreciated that the various aspects, embodiments, implementations and features of the described embodiments may be used separately or in any combination. Various aspects of the described embodiments may be implemented via computer program product, which may be provided via a computer-readable medium, such as memory 314, storing software and/or firmware, hardware, or a combination of hardware and software.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “I” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

What is claimed is:

1. A method for testing a vehicle fire suppression system, the method comprising:
testing, via processing circuitry, each of a plurality of components of the vehicle fire suppression system; and
providing test results for each of the plurality of components.

2. The method of claim 1, wherein providing test results comprises generating a log comprising test results for each of the plurality of components.

3. The method of claim 2, further comprising:
saving the log to a memory of the vehicle fire suppression system.

4. The method of claim 2, further comprising:
exporting the log from the vehicle fire suppression system to an external computing device.

5. The method of claim 1, wherein the plurality of components of the vehicle fire suppression system are categorized into a plurality of component groups based at least in part on component type, wherein each component group comprises at least one component, and wherein:
testing comprises sequentially testing each component group; and
providing test results comprises providing test results for each component group.

6. The method of claim 1, wherein the test results comprise, for each respective component group, one or more of an operational status for at least one component in the respective component group or a count of a number of detected functional components in the respective group.

7. The method of claim 1, wherein the plurality of components comprises a temperature sensor, and wherein the test results comprise at least one temperature measured by the temperature sensor.

8. The method of claim 7, wherein the at least one temperature comprises one or more of temperature measured by the temperature sensor during the test, a maximum temperature measured by the temperature sensor over a period of time preceding the test, or a minimum temperature measured by the temperature sensor over the period of time preceding the test.

9. The method of claim 1, wherein the plurality of components comprises a shutdown relay configured to disable vehicle operation in event of a fire, and wherein testing comprises engaging the shutdown relay.

10. The method of claim 1, wherein the plurality of components comprises an extinguishing agent container, and wherein testing comprises testing pressurization of the extinguishing agent container.

11. The method of claim 1, wherein the plurality of components comprises a plurality of status indicator lights, and wherein testing comprises activating each of the plurality of status indicator lights.

12. A control system for a vehicle fire suppression system, the control system comprising processing circuitry configured to cause the control system to at least:
test each of a plurality of components of the vehicle fire suppression system; and
provide test results for each of the plurality of components.

13. The control system of claim 12, wherein the processing circuitry is configured to cause the control system to provide test results at least in part by causing the control system to generate a log comprising test results for each of the plurality of components.

14. The control system of claim 12, wherein the plurality of components of the vehicle fire suppression system are categorized into a plurality of component groups based at least in part on component type, wherein each component group comprises at least one component, and wherein the processing circuitry is configured to cause the control system to:
test each of the plurality of components at least in part by sequentially testing each component group; and
provide test results at least in part by providing test results for each component group.

15. The control system of claim 12, wherein the plurality of components comprises a temperature sensor, and wherein the test results comprise at least one temperature measured by the temperature sensor.

16. The control system of claim 12, wherein the plurality of components comprises one or more status indicator lights, a shutdown relay configured to disable vehicle operation in event of a fire, a power supply system, at least one fire detection sensor, an audible alarm, and an extinguishing agent container, and wherein the processing circuitry is configured to cause the control system to test each of a plurality of components at least in part by:
testing operation of each of the one or more status indicator lights;
engaging the shutdown relay;
testing the power supply system;
testing the at least one fire detection sensor;
triggering the audible alarm; and
testing pressurization of the extinguishing agent container.

17. The control system of claim 12, wherein the processing circuitry is further configured to cause actuation of the fire suppression system in response to detecting a fire condition.

18. A vehicle fire suppression system comprising:
an extinguishing agent delivery system comprising an extinguishing agent container and an actuator configured to trigger release of extinguishing agent from the extinguishing agent container;
a plurality of fire detection sensors; and
a control system operatively coupled with the plurality of fire detection sensors and with the actuator, wherein the control system comprises processing circuitry configured to cause the control system to at least:
perform a test of at least one component of the extinguishing agent delivery system and the plurality of fire detection sensors; and
provide test results for each of the at least one component of the extinguishing agent delivery system and for the plurality of fire detection sensors.

19. The vehicle fire suppression system of claim 18, wherein the processing circuitry is configured to cause the control system to provide the test results at least in part by generating a log comprising the test results.

20. The vehicle fire suppression system of claim 18, wherein the test results comprise a sensor type indication for each of the plurality of fire detection sensors.

21. The vehicle fire suppression system of claim 18, wherein the plurality of fire detection sensors comprises a temperature sensor, and wherein the test results comprise at least one temperature measured by the temperature sensor.

22. The vehicle fire suppression system of claim 18, wherein the control system further comprises a display, and wherein the processing circuitry is further configured to cause the control system to display test status information on the display during the test.

23. The vehicle fire suppression system of claim 18, wherein the control system comprises a user input device in operative communication with the processing circuitry, wherein the processing circuitry is further configured to:
perform the test in response to actuation of the user input device in a first manner;
perform a second test in response to actuation of the user input device in a second manner, wherein the second test provides one of an indication that the vehicle fire suppression system is operating properly or that there is a fault in the vehicle fire suppression system; and
perform a third test in response to actuation of the user input device in a third manner, wherein the third test tests operation of a shutdown relay implemented in the vehicle fire suppression system.
